(19) United States
(12) Patent Application Publication
(10) Pub. No.: US 2024/0348206 A1
(43) Pub. Date: Oct. 17, 2024

(54) METHOD FOR DIAGNOSING INTERNAL LOSS MECHANISM OF SOLAR CELL

(71) Applicant: Anhui University, Hefei (CN)

(72) Inventors: Xingang REN, Hefei (CN); Shengyang WEI, Hefei (CN); Zhaosheng XIA, Hefei (CN); Zhixiang HUANG, Hefei (CN); Wei SHA, Hefei (CN); Lihua WANG, Hefei (CN); Gang WANG, Hefei (CN); Bo WU, Hefei (CN); Yingsong LI, Hefei (CN); Zhiliang CHEN, Hefei (CN); Yong PENG, Hefei (CN)

(21) Appl. No.: 18/737,928

(22) Filed: Jun. 7, 2024

(30) Foreign Application Priority Data
Feb. 5, 2024 (CN) 202410163721.8

(51) Int. Cl. H02S 50/10

(52) U.S. Cl. CPC H02S 50/10

(57) ABSTRACT

A method for diagnosing an internal loss mechanism of a solar cell is provided. The solar cell includes an anode and a cathode. An electron transport layer, an active layer and a hole transport layer are arranged in sequence from top to bottom between the cathode and the anode. The solar cell is modeled through a solar cell multi-physics simulation platform. Current density-voltage (JV) curves respectively of type A, type B, type C and type D are simulated by regulating a bulk defect and a surface defect of the active layer and a voltage scan rate. The solar cell is subjected to forward voltage scan and reverse voltage scan to obtain forward and reverse JV curves. According to the forward and reverse JV curves, whether the JV curve type of the solar cell is the type A, the type B, the type C or the type D is determined.

### CROSS-REFERENCE TO RELATED APPLICATIONS

This application claims the benefit of priority from Chinese Patent Application No. 202410163721.8, filed on Feb. 5, 2024. The content of the aforementioned application, including any intervening amendments made thereto, is incorporated herein by reference in its entirety.

### TECHNICAL FIELD

This application relates to solar cells, and more particularly to a method for diagnosing an internal loss mechanism of a solar cell.

### BACKGROUND

The rapid development of social economy and science and technology has led to an increasing demand for energy sources, and the continuous consumption of nonrenewable fossil fuel sources makes the energy crisis increasingly serious. As a renewable energy source, solar energy has been widely accepted as an effective approach to overcome the energy crisis. Moreover, the development of the solar photovoltaic industry is also conducive to alleviating and improving environmental pollution problems. The remarkable development of photovoltaic technology in recent years has made the solar cells cost-effective and reliable. The existing photovoltaic industry is predominated by the first-generation silicon-based thin-film solar cells and second-generation inorganic thin-film solar cells, and the emerging third-generation solar cells mainly including organic solar cells and perovskite solar cells have attracted widespread attention in the photovoltaic field. The certified efficiency of existing single-junction perovskite solar cells has reached 26.1%, which has met the efficiency requirements of commercial production. However, due to the existence of internal loss mechanisms, the development of the solar cell efficiency is restricted.

Therefore, it is necessary to provide a method for diagnosing the internal loss mechanism of solar cells to solve the above problems.

### SUMMARY

An object of the disclosure is to provide a method for diagnosing an internal loss mechanism of a solar cell, in which the internal loss mechanism is determined by analyzing the type of a simulated current density-voltage (JV) curve.

In order to achieve the above object, this application provides a method for diagnosing an internal loss mechanism of a solar cell, wherein the solar cell comprises an anode and a cathode; an electron transport layer, an active layer and a hole transport layer are arranged in sequence from top to bottom between the cathode and the anode; and the method comprises:
(S1) modeling the solar cell through a solar cell multi-physics simulation platform, simulating current density-voltage (JV) curves respectively of type A, type B, type C and type D by regulating a bulk defect and a surface defect of the active layer and a voltage scan rate; and
(S2) subjecting the solar cell to forward voltage scan to obtain a forward JV curve; subjecting the solar cell to reverse voltage scan to obtain a reverse JV curve; and determining whether a JV curve type of the solar cell is the type A, the type B, the type C or the type D based on the forward JV curve and the reverse JV curve.

In some embodiments, the solar cell multi-physics simulation platform is configured to model the solar cell by solving a solar cell drift-diffusion model with ion migration, expressed as:

$${ε}_{0} {ε}_{r} \frac{{\partial }^{2} φ}{\partial {x}^{2}} = - q ( p - n + c - {N}_{c \_ static} - a + {N}_{a \_ static} + {N}_{A} - {N}_{D} ) ; \qquad ( 1 )$$

wherein equation (1) is a Poisson equation, ε₀, is a vacuum dielectric constant, εᵣ is a relative dielectric constant,

$$\frac{{\partial }^{2} φ}{\partial {x}^{2}}$$

is a second-order partial derivative of an electrostatic potential with respect to a spatial x-axis, p is a hole concentration, n is an electron concentration, q is a unit charge, c is a cation concentration, N_{c_static} is a cation vacancy, a is an anion concentration, N_{a_static} is an anion vacancy, N_{A} is a doping acceptor concentration, and N_{D} is a doping donor concentration;
an electron drift-diffusion equation is expressed as equation (2):

$${J}_{n} = q {μ}_{n} ( - n \frac{\partial {φ}_{n}}{\partial x} + {k}_{B} T \frac{\partial n}{\partial x} ) ; \qquad ( 2 )$$

an electron current continuity equation is expressed as equation (3):

$$\frac{\partial n}{\partial t} = \frac{1}{q} \frac{\partial {J}_{n}}{\partial x} + G - R ; \qquad ( 3 )$$

wherein in equations (2) and (3), Jₙ is an electron current density, q is the unit charge, μₙ is an electron mobility, n is the electron concentration,

$$\frac{\partial {φ}_{n}}{\partial x}$$

is a partial derivative of an electron Fermi potential with respect to the spatial x-axis, k_{B} is a Boltzmann constant, T is temperature,

$$\frac{\partial n}{\partial x}$$

is a partial derivative of the electron concentration with respect to the spatial x-axis,

$$\frac{\partial n}{\partial t}$$

is a partial derivative of the electron concentration with respect to time,

$$\frac{\partial {J}_{n}}{\partial x}$$

is a partial derivative of the electron current density with respect to the spatial x-axis, G is a carrier generation rate, and R is a carrier recombination rate;
a hole drift-diffusion equation is expressed as equation (4):

$${J}_{p} = q {μ}_{p} ( - p \frac{\partial {φ}_{p}}{\partial x} - {k}_{B} T \frac{\partial p}{\partial x} ) ; \qquad ( 4 )$$

a hole current continuity equation is expressed as equation (5):

$$\frac{\partial p}{\partial t} = - \frac{1}{q} \frac{\partial {J}_{p}}{\partial x} + G - R ; \qquad ( 5 )$$

wherein in equations (4) and (5), Jₚ is a hole current density, q is the unit charge, μₚ is a hole mobility, p is the hole concentration,

$$\frac{\partial {φ}_{p}}{\partial x}$$

is a partial derivative of a hole Fermi potential with respect to the spatial x-axis, k_{B} is the Boltzmann constant, T is the temperature,

$$\frac{\partial p}{\partial x}$$

is a partial derivative of the hole concentration with respect to the spatial x-axis,

$$\frac{\partial p}{\partial t}$$

is a partial derivative of the hole concentration with respect to the time,

$$\frac{\partial {J}_{p}}{\partial x}$$

is a partial derivative of the hole current density with respect to the spatial x-axis, G is the carrier generation rate, and R is the carrier recombination rate;
a cation drift-diffusion equation is expressed as equation (6):

$${J}_{c} = q {μ}_{c} ( - c \frac{\partial {φ}_{c}}{\partial x} - {k}_{B} T \frac{\partial c}{\partial x} ) ; \qquad ( 6 )$$

a cation current continuity equation is expressed as equation (7):

$$\frac{\partial c}{\partial t} = - \frac{1}{q} \frac{\partial {J}_{c}}{\partial x} ; \qquad ( 7 )$$

wherein in equations (6) and (7), J_{c} is a cation current density, q is the unit charge, μ_{c} is a cation mobility, c is the cation concentration,

$$\frac{\partial {φ}_{c}}{\partial x}$$

is a partial derivative of a cation electrostatic potential with respect to the spatial x-axis, k_{B} is the Boltzmann constant, T is the temperature,

$$\frac{\partial c}{\partial x}$$

is a partial derivative of the cation concentration with respect to the spatial x-axis,

$$\frac{\partial c}{\partial t}$$

is a partial derivative of the cation concentration with respect to the time, and

$$\frac{\partial {J}_{c}}{\partial x}$$

is a partial derivative of the cation current density with respect to the spatial x-axis;
an anion drift-diffusion equation is expressed as equation (8):

$${J}_{a} = q {μ}_{a} ( - a \frac{\partial {φ}_{a}}{\partial x} + {k}_{B} T \frac{\partial a}{\partial x} ) ; \qquad ( 8 )$$

an anion current continuity equation is expressed as equation (9):

$$\frac{\partial a}{\partial t} = \frac{1}{q} \frac{\partial {J}_{a}}{\partial x} ; \qquad ( 9 )$$

wherein in equations (8) and (9), Jₐ is an anion current density, q is the unit charge, μₐ is an anion mobility, a is the anion concentration,

$$\frac{\partial {φ}_{a}}{\partial x}$$

is a partial derivative of an anion electrostatic potential with respect to the spatial x-axis, k_{B} is the Boltzmann constant, T is the temperature,

$$\frac{\partial a}{\partial x}$$

is a partial derivative of the anion concentration with respect to the spatial x-axis,

$$\frac{\partial a}{\partial t}$$

is a partial derivative or the anion concentration with respect to the time, and

$$\frac{\partial {J}_{a}}{\partial x}$$

is a partial derivative of the anion current density with respect to the spatial x-axis;
the solar cell drift-diffusion model is solved using a Scharfetter-Gummel discretization, expressed as equations (10)-(14):

$$[ - 2 \times \frac{{ε}_{i + 1 / 2} + {ε}_{i - 1 / 2}}{2 Δ {x}^{2}} - \frac{{n}_{i}^{j} + {p}_{i}^{j}}{{k}_{B} T} ] {φ}_{i}^{j} + {ε}_{i + \frac{1}{2}} \frac{{φ}_{i + 1}^{j}}{Δ {x}^{2}} + {ε}_{i - \frac{1}{2}} \frac{{φ}_{i - 1}^{j}}{Δ {x}^{2}} = - q ( {p}_{i}^{j} - {n}_{i}^{j} + {N}_{D} - {N}_{A} + c - {N}_{c \_ static} - a + {N}_{a \_ static} ) - \frac{{φ}_{i}^{j - 1} ( {n}_{i}^{j} + {p}_{i}^{j} )}{{k}_{B} T} ; \qquad ( 10 )$$

wherein the equation (10) is a discrete form of the equation (1), ε_{i+1/2} is a mean value of a dielectric constant at a spatial coordinate i and a dielectric constant at a spatial coordinate i+1, ε_{i-1/2} is a mean value of a dielectric constant at a spatial coordinate i−1 and the dielectric constant at the spatial coordinate i, Δx is a unit spatial step, nᵢ^{j} is an electron concentration at the spatial coordinate i and a time coordinate j, pᵢ^{j} is a hole concentration at the spatial coordinate i and the time coordinate j, k_{B}, is the Boltzmann constant, T is the temperature, φᵢ^{j} is an electrostatic potential at the spatial coordinate i and the time coordinate j, φᵢ₊₁^{j} is an electrostatic potential at the spatial coordinate i+1 and the time coordinate j, φᵢ₋₁^{j} is an electrostatic potential at the spatial coordinate i−1 and the time coordinate j, q is the unit charge, c is the cation concentration, N_{c_static} is the cation vacancy, N_{a_static} is the anion vacancy, N_{A} is the doping acceptor concentration, and N_{D} is the doping donor concentration;

$$[ \frac{1}{Δ t} + \frac{{D}_{{n}_{i + 1 / 2}}}{Δ {x}^{2}} B ( \frac{{φ}_{n , i} - {φ}_{n , i + 1}}{{k}_{B} T} ) + \frac{{D}_{{n}_{i - 1 / 2}}}{Δ {x}^{2}} B ( \frac{{φ}_{n , i} - {φ}_{n , i - 1}}{{k}_{B} T} ) + {k}_{rad} {p}_{i}^{j - 1} + \frac{{p}_{i}^{j - 1}}{{τ}_{n} ( {p}_{i}^{j - 1} + {p}_{t} ) + {τ}_{p} ( {n}_{i}^{j - 1} + {n}_{t} )} ] {n}_{i}^{j} - [ \frac{{D}_{{n}_{i + 1 / 2}}}{Δ {x}^{2}} B ( \frac{{φ}_{n , i + 1} - {φ}_{n , i}}{{k}_{B} T} ) ] {n}_{i + 1}^{j} - [ \frac{{D}_{{n}_{i - 1 / 2}}}{Δ {x}^{2}} B ( \frac{{φ}_{n , i - 1} - {φ}_{n , i}}{{k}_{B} T} ) ] {n}_{i - 1}^{j} = \frac{{n}_{i}^{j - 1}}{Δ t} + {G}_{i} - \frac{{n}_{in}^{2}}{{τ}_{n} ( {p}_{i}^{j - 1} + {p}_{t} ) + {τ}_{p} ( {n}_{i}^{j - 1} + {n}_{t} )} - {k}_{rad} {n}_{in}^{2} ; \qquad ( 11 )$$

wherein the equation (11) is a discrete form of a combination of the equation (2) and the equation (3), Δt is a unit time step, Dₙ_{_{i+1/2}} is a mean value of an electron diffusion coefficient at the spatial coordinate i and an electron diffusion coefficient at the spatial coordinate i+1,

$$B ( \frac{{φ}_{n , i} - {φ}_{n , i + 1}}{{k}_{B} T} )$$

is a Bernoulli's equation with a variable

$$\frac{{φ}_{n , i} - {φ}_{n , i + 1}}{{k}_{B} T} ,$$

φ_{n,i} is an electron Fermi potential at the spatial coordinate i, φ_{n,i+1} is an electron Fermi potential at the spatial coordinate i+1, Dₙ_{_{i+1/2}} is a mean value of an electron diffusion coefficient at the spatial coordinate i−1 and the electron diffusion coefficient at the spatial coordinate i,

$$B ( \frac{{φ}_{n , i} - {φ}_{n , i - 1}}{{k}_{B} T} )$$

is a Bernoulli's equation with a variable

$$\frac{{φ}_{n , i} - {φ}_{n , i - 1}}{{k}_{B} T} ,$$

φ_{n,i-1} is an electron Fermi potential at the spatial coordinate i−1, k_{rad} is a radiation recombination coefficient, τₙ is a minority electron lifetime, pₜ is a defect hole concentration, τₚ is a minority hole lifetime, nₜ is a defect electron concentration, pᵢ^{j-1} is a hole concentration at the spatial coordinate i and a time coordinate j−1, nᵢ^{j} is the electron concentration at the spatial coordinate i and the time coordinate j,

$$B ( \frac{{φ}_{n , i + 1} - {φ}_{n , i}}{{k}_{B} T} )$$

is a Bernoulli's equation with a variable

$$\frac{{φ}_{n , i + 1} - {φ}_{n , i}}{{k}_{B} T} ,$$

nᵢ₊₁^{j} is an electron concentration at the spatial coordinate i+1 and the time coordinate j,

$$B ( \frac{{φ}_{n , i - 1} - {φ}_{n , i}}{{k}_{B} T} )$$

is a Bernoulli's equation with a variable

$$\frac{{φ}_{n , i - 1} - {φ}_{n , i}}{{k}_{B} T} ,$$

nᵢ₋₁^{j} is an electron concentration at the spatial coordinate i−1 and the time coordinate j, nᵢ^{j-1} is an electron concentration at the spatial coordinate i and the time coordinate j−1, Gᵢ is a carrier generation rate at the spatial coordinate i, and nᵢₙ² is a square of an intrinsic carrier concentration;

$$[ \frac{1}{Δ t} + \frac{{D}_{{p}_{i + 1 / 2}}}{Δ {x}^{2}} B ( - \frac{{φ}_{p , i} - {φ}_{p , i + 1}}{{k}_{B} T} ) + \frac{{D}_{{p}_{i - 1 / 2}}}{Δ {x}^{2}} B ( - \frac{{φ}_{p , i} - {φ}_{p , i - 1}}{{k}_{B} T} ) + {k}_{rad} {n}_{i}^{j - 1} + \frac{{n}_{i}^{j - 1}}{{τ}_{n} ( {p}_{i}^{j - 1} + {p}_{t} ) + {τ}_{p} ( {n}_{i}^{j - 1} + {n}_{t} )} ] {p}_{i}^{j} - [ \frac{{D}_{{p}_{i + 1 / 2}}}{Δ {x}^{2}} B ( - \frac{{φ}_{p , i + 1} - {φ}_{p , i}}{{k}_{B} T} ) ] {p}_{i + 1}^{j} - [ \frac{{D}_{{p}_{i - 1 / 2}}}{Δ {x}^{2}} B ( - \frac{{φ}_{p , i - 1} - {φ}_{p , i}}{{k}_{B} T} ) ] {p}_{i - 1}^{j} = \frac{{p}_{i}^{j - 1}}{Δ t} + {G}_{i} - \frac{{n}_{in}^{2}}{{τ}_{n} ( {p}_{i}^{j - 1} + {p}_{t} ) + {τ}_{p} ( {n}_{i}^{j - 1} + {n}_{t} )} - {k}_{rad} {n}_{in}^{2} ; \qquad ( 12 )$$

wherein the equation (12) is a discrete form of a combination of the equation (4) and the equation (5), Δt is the unit time step, Dₚ_{_{i+1/2}} is a mean value of a hole diffusion coefficient at the spatial coordinate i and a hole diffusion coefficient at the spatial coordinate i+1,

$$B ( - \frac{{φ}_{p , i} - {φ}_{p , i + 1}}{{k}_{B} T} )$$

is a Bernoulli's equation with a variable

$$- \frac{{φ}_{p , i} - {φ}_{p , i + 1}}{{k}_{B} T} ,$$

φ_{p,i} is a hole Fermi potential at the spatial coordinate i, φ_{p,i+1} is a hole Fermi potential at the spatial coordinate i+1, Dₚ_{_{i−1/2}} is a mean value of a hole diffusion coefficient at the spatial coordinate i−1 and the hole diffusion coefficient at the spatial coordinate i,

$$B ( - \frac{{φ}_{p , i} - {φ}_{p , i - 1}}{{k}_{B} T} )$$

is a Bernoulli's equation with a variable

$$- \frac{{φ}_{p , i} - {φ}_{p , i - 1}}{{k}_{B} T} ,$$

φ_{p,i-1} is a hole Fermi potential at the spatial coordinate i−1, k_{rad} is the radiation recombination coefficient, nᵢ^{j-1} is the electron concentration at the spatial coordinate i and the time coordinate j−1, τₙ is the minority electron lifetime, pₜ is the defect hole concentration, τₚ is the minority hole lifetime, nₜ is the defect electron concentration, pᵢ^{j} is the hole concentration at the spatial coordinate i and the time coordinate j,

$$B ( - \frac{{φ}_{p , i + 1} - {φ}_{p , i}}{{k}_{B} T} )$$

is a Bernoulli's equation with a variable

$$- \frac{{φ}_{p , i + 1} - {φ}_{p , i}}{{k}_{B} T} ,$$

pᵢ₊₁^{j} is a hole concentration at the spatial coordinate i+1 and the time coordinate j,

$$B ( - \frac{{φ}_{p , i - 1} - {φ}_{p , i}}{{k}_{B} T} )$$

is a Bernoulli's equation with a variable

$$- \frac{{φ}_{p , i - 1} - {φ}_{p , i}}{{k}_{B} T} ,$$

pᵢ₋₁^{j} is a hole concentration at the spatial coordinate i−1 and the time coordinate j, pᵢ^{j-1} is the hole concentration at the spatial coordinate i and the time coordinate j−1, Gᵢ is the carrier generation rate at the spatial coordinate i, and nᵢₙ² is the square of the intrinsic carrier concentration;

$$[ \frac{1}{Δ t} + \frac{{D}_{{c}_{i + 1 / 2}}}{Δ {x}^{2}} B ( - \frac{{φ}_{c , i} - {φ}_{c , i + 1}}{{k}_{B} T} ) + \frac{{D}_{{c}_{i - 1 / 2}}}{Δ {x}^{2}} B ( - \frac{{φ}_{c , i} - {φ}_{c , i - 1}}{{k}_{B} T} ) ] {c}_{i}^{j} - [ \frac{{D}_{{c}_{i + 1 / 2}}}{Δ {x}^{2}} B ( - \frac{{φ}_{c , i + 1} - {φ}_{c , i}}{{k}_{B} T} ) ] {c}_{i + 1}^{j} - [ \frac{{D}_{{c}_{i - 1 / 2}}}{Δ {x}^{2}} B ( - \frac{{φ}_{c , i - 1} - {φ}_{c , i}}{{k}_{B} T} ) ] {c}_{i - 1}^{j} = \frac{{c}_{i}^{j - 1}}{Δ t} ; \qquad ( 13 )$$

wherein the equation (13) is a discrete form of a combination of the equation (6) and the equation (7), Δt is the unit time step, D_{c}_{_{i+1/2}} is a mean value of a cation diffusion coefficient at the spatial coordinate i and a cation diffusion coefficient at the spatial coordinate i+1,

$$B ( - \frac{{φ}_{c , i} - {φ}_{c , i + 1}}{{k}_{B} T} )$$

is a Bernoulli's equation with a variable

$$- \frac{{φ}_{c , i} - {φ}_{c , i + 1}}{{k}_{B} T} ,$$

φ_{c,i} is a cation electrostatic potential at the spatial coordinate i, φ_{c,i+1} is a cation electrostatic potential at the spatial coordinate i+1, D_{c}_{_{i−1/2}} is a mean value of a cation diffusion coefficient at the spatial coordinate i−1 and the cation diffusion coefficient at the spatial coordinate i,

$$B ( - \frac{{φ}_{c , i} - {φ}_{c , i - 1}}{{k}_{B} T} )$$

is a Bernoulli's equation with a variable

$$- \frac{{φ}_{c , i} - {φ}_{c , i - 1}}{{k}_{B} T} ,$$

φ_{c,i-1} is a cation electrostatic potential at the spatial coordinate i−1, cᵢ^{j} is a cation concentration at the spatial coordinate i and the time coordinate j,

$$B ( - \frac{{φ}_{c , i + 1} - {φ}_{c , i}}{{k}_{B} T} )$$

is a Bernoulli's equation with a variable

$$\\ - \frac{{φ}_{c , i + 1} - {φ}_{c , i}}{{k}_{B} T} ,$$

cᵢ₊₁^{j} is a cation concentration at the spatial coordinate i+1 and the time coordinate j,

$$\\ B ( - \frac{{φ}_{c , i - 1} - {φ}_{c , i}}{{k}_{B} T} )$$

is a Bernoulli's equation with a variable

$$\\ - \frac{{φ}_{c , i - 1} - {φ}_{c , i}}{{k}_{B} T} ,$$

cᵢ₋₁^{j} is a cation concentration at the spatial coordinate i−1 and the time coordinate j, and cᵢ^{j-1} is a cation concentration at the spatial coordinate i and the time coordinate j−1;

$$\\ \begin{matrix}[ \frac{1}{Δ t} + \frac{{D}_{{a}_{i + 1 / 2}}}{Δ {x}^{{}_{} 2}} B ( \frac{{φ}_{a , i} - {φ}_{a , i + 1}}{{k}_{B} T} ) + \frac{{D}_{{a}_{i - 1 / 2}}}{Δ {x}^{{}_{} 2}} B ( \frac{{φ}_{a , i} - {φ}_{a , i - 1}}{{k}_{B} T} ) ] {a}_{i}^{{}_{} j} - [ \frac{{D}_{{a}_{i + 1 / 2}}}{Δ {x}^{{}_{} 2}} B ( \frac{{φ}_{a , i + 1} - {φ}_{a , i}}{{k}_{B} T} ) ] {a}_{i + 1}^{{}_{} j} - [ \frac{{D}_{{a}_{i - 1 / 2}}}{Δ {x}^{{}_{} 2}} B ( \frac{{φ}_{a , i - 1} - {φ}_{a , i}}{{k}_{B} T} ) ] {a}_{i - 1}^{{}_{} j} = \frac{{a}_{i}^{{}_{} j - 1}}{Δ t} ; & ( 14 )\end{matrix}$$

wherein the equation (14) is a discrete form of a combination of the equation (8) and the equation (9), Δt is the unit time step, Dₐ_{_{i+1/2}} is a mean value of an anion diffusion coefficient at the spatial coordinate i and an anion diffusion coefficient at the spatial coordinate i+1,

$$\\ B ( \frac{{φ}_{a , i} - {φ}_{a , i + 1}}{{k}_{B} T} )$$

is a Bernoulli's equation with a variable

$$\\ \frac{{φ}_{a , i} - {φ}_{a , i + 1}}{{k}_{B} T} ,$$

φ_{a,i} is an anion electrostatic potential at the spatial coordinate i, φ_{a,i+1} is an anion electrostatic potential at the spatial coordinate i+1, Dₐ_{_{i−1/2}} is a mean value of an anion diffusion coefficient at the spatial coordinate i−1 and the anion diffusion coefficient at the spatial coordinate i,

$$\\ B ( \frac{{φ}_{a , i} - {φ}_{a , i - 1}}{{k}_{B} T} )$$

is a Bernoulli's equation with a variable

$$\\ \frac{{φ}_{a , i} - {φ}_{a , i - 1}}{{k}_{B} T} ,$$

φ_{a,i-1} is an anion electrostatic potential at the spatial coordinate i−1, aᵢ^{j} is an anion concentration at the spatial coordinate i and the time coordinate j,

$$\\ B ( \frac{{φ}_{a , i + 1} - {φ}_{a , i}}{{k}_{B} T} )$$

is a Bernoulli's equation with a variable

$$\\ \frac{{φ}_{a , i + 1} - {φ}_{a , i}}{{k}_{B} T} ,$$

aᵢ₊₁^{j} is an anion concentration at the spatial coordinate i+1 and the time coordinate j,

$$\\ B ( \frac{{φ}_{a , i - 1} - {φ}_{a , i}}{{k}_{B} T} )$$

is a Bernoulli's equation with a variable

$$\\ \frac{{φ}_{a , i - 1} - {φ}_{a , i}}{{k}_{B} T} ,$$

aᵢ₋₁^{j} is an anion concentration at the spatial coordinate i−1 and the time coordinate j, and aᵢ^{j-1} is an anion concentration at the spatial coordinate i and the time coordinate j−1.

In some embodiments, in the step (S2), if the JV curve type of the solar cell is the type B, the internal loss mechanism is determined as the surface defect of the active layer;
if the JV curve type of the solar cell is the type A, the internal loss mechanism is determined as the bulk defect of the active layer or a combination of the bulk defect and the surface defect of the active layer; and in this case, the voltage scan rate is increased, and the step (S2) is repeated until the JV curve type of the solar cell is the type C or the type D;
if the JV curve type of the solar cell is the type C, the internal loss mechanism is determined as the bulk defect of the active layer; and
if the JV curve type of the solar cell is the type D, the internal loss mechanism is determined as the combination of the bulk defect and the surface defect of the active layer.

Therefore, the method of the present disclosure adopts the analysis according to the types of simulated JV curves, so as to diagnose a corresponding internal loss mechanism of the solar cell.

The technical solutions of the present disclosure will be further described in detail below with reference to the accompanying drawings and embodiments.

### BRIEF DESCRIPTION OF THE DRAWINGS

FIG. 1 is a schematic diagram of a solar cell simulated by a solar cell multi-physics simulation platform in accordance with an embodiment of the present disclosure;

FIG. 2 is a flow chart of a method for diagnosing an internal loss mechanism of the solar cell in accordance with an embodiment of the present disclosure;

FIGS. 3a-d illustrate (current density-voltage) JV curves respectively of type A, type B, type C and type D in accordance with an embodiment of the present disclosure;

FIG. 4 shows a forward-reverse JV curve of the solar cell in accordance with Embodiment 1 of the present disclosure;

FIG. 5 shows a forward-reverse JV curve of the solar cell in accordance with Embodiment 2 of the present disclosure; and

FIG. 6 shows a forward-reverse JV curve of the solar cell in accordance with Embodiment 3 of the present disclosure.

In the drawings: 1. cathode; 2. electron transport layer; 3. active layer; 4. hole transport layer; and 5. anode.

### DETAILED DESCRIPTION OF EMBODIMENTS

The technical solutions of the present disclosure will be further described in detail below with reference to the accompanying drawings and embodiments.

The term “comprise” or “include” are used in the present disclosure is intended to indicate that the elements before term include the elements listed after the term, and do not exclude the possibility of encompassing other elements as well. The orientation or position relationships indicated by terms such as “inside”, “outer”, “upper” and “lower” are based on the orientation or position relationships shown in the drawings, which are merely for the convenience of describing the present application and simplifying the description, but not intended to indicate or imply that the device or element referred to must have a particular orientation, or be constructed or operated in a particular orientation, and therefore cannot be construed as a limitation of the present application. When the absolute position of the described object changes, the relative position relationship may also change accordingly. In the present disclosure, unless otherwise clearly stated and limited, the term “attached” should be understood in a broad sense. For example, it can be a fixed connection, a detachable connection, an integrated state, a direct connection, an indirect connection through an intermediate medium, an internal connection between two elements or an interactive relationship between two elements. For those of ordinary skill in the art, the specific meanings of the above terms in the present disclosure can be understood according to specific circumstances.

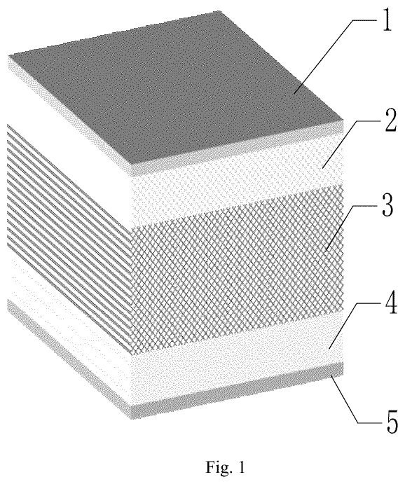

A method for diagnosing an internal loss mechanism of a solar cell is provided. As shown in FIG. 1, the solar cell includes an anode 5 and a cathode 1. An electron transport layer 2, an active layer 3 and a hole transport layer 4 are arranged in sequence from top to bottom between the cathode 1 and the anode 5.

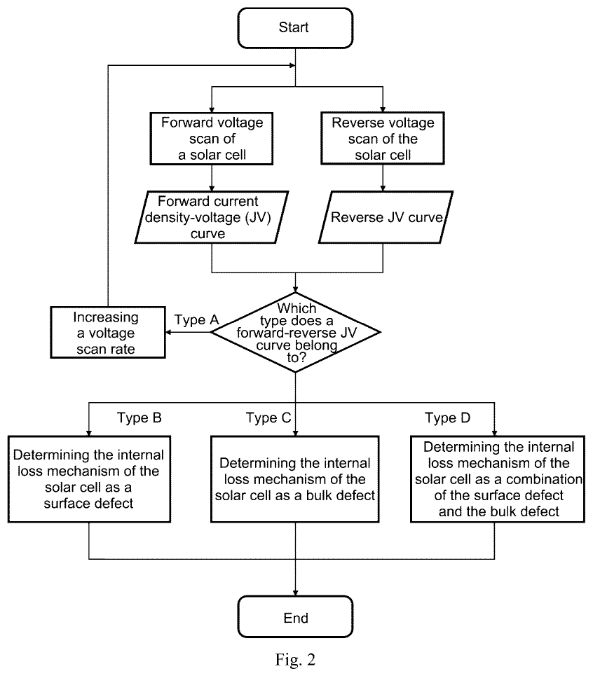

The method includes the following steps, as shown in FIG. 2.

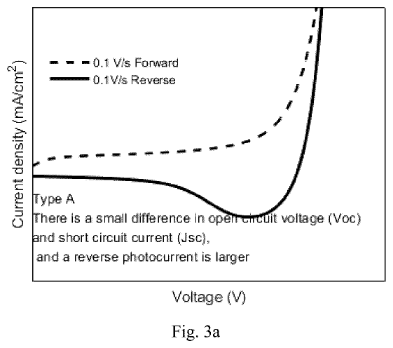

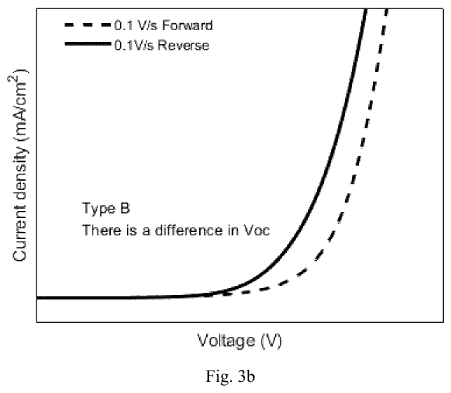

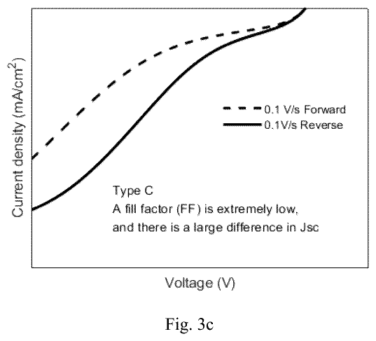

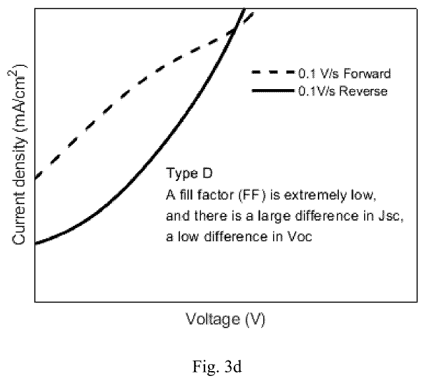

(S1) The solar cell is modeled through a solar cell multi-physics simulation platform. Current density-voltage (JV) curves respectively of type A, type B, type C and type D are simulated by regulating a bulk defect and a surface defect of the active layer 3 and a voltage scan rate, as shown in FIGS. 3a-d.

The solar cell multi-physics simulation platform is configured to model the solar cell by solving a solar cell drift-diffusion model with ion migration expressed as follows.

$$\\ \begin{matrix}{ε}_{0} {ε}_{r} \frac{{\partial }^{{}_{} 2} φ}{\partial {x}^{{}_{} 2}} = - q ( p - n + c - {N}_{c \_ static} - a + {N}_{a \_ static} + {N}_{A} - {N}_{D} ) & ( 1 )\end{matrix}$$

Equation (1) is a Poisson equation, where ε₀ is a vacuum dielectric constant, εᵣ is a relative dielectric constant,

$$\\ \frac{{\partial }^{{}_{} 2} φ}{\partial {x}^{{}_{} 2}}$$

is a second-order partial derivative of an electrostatic potential with respect to a spatial x-axis, p is a hole concentration, n is an electron concentration, q is a unit charge, c is a cation concentration, N_{c_static} is a cation vacancy, a is an anion concentration, N_{a_static} is an anion vacancy, N_{A} is a doping acceptor concentration, and N_{D} is a doping donor concentration.

An electron drift-diffusion equation is expressed as Equation (2).

$$\\ \begin{matrix}{J}_{n} = q {μ}_{n} ( - n \frac{\partial {φ}_{n}}{\partial x} + {k}_{B} T \frac{\partial n}{\partial x} ) & ( 2 )\end{matrix}$$

An electron current continuity equation is expressed as Equation (3).

$$\frac{\partial n}{\partial t} = \frac{1}{q} \frac{\partial {J}_{n}}{\partial x} + G - R \qquad ( 3 )$$

In Equations (2) and (3), Jₙ is an electron current density, q is the unit charge, μₙ is an electron mobility, n is the electron concentration,

$$\frac{\partial {φ}_{n}}{\partial x}$$

is a partial derivative of an electron Fermi potential with respect to the spatial x-axis, k_{B} is a Boltzmann constant, T is temperature,

$$\frac{\partial n}{\partial x}$$

is a partial derivative of the electron concentration with respect to the spatial x-axis,

$$\frac{\partial n}{\partial t}$$

is a partial derivative of the electron concentration with respect to time,

$$\frac{\partial {J}_{n}}{\partial x}$$

is a partial derivative of the electron current density with respect to the spatial x-axis, G is a carrier generation rate, and R is a carrier recombination rate.

A hole drift-diffusion equation is expressed as Equation (4).

$${J}_{p} = q {μ}_{p} ( - p \frac{\partial {φ}_{p}}{\partial x} - {k}_{B} T \frac{\partial p}{\partial x} ) \qquad ( 4 )$$

A hole current continuity equation is expressed as Equation (5).

$$\frac{\partial p}{\partial t} = - \frac{1}{q} \frac{\partial {J}_{p}}{\partial x} + G - R \qquad ( 5 )$$

In equations (4) and (5), Jₚ is a hole current density, q is the unit charge, μₚ is a hole mobility, p is the hole concentration,

$$\frac{\partial {φ}_{p}}{\partial x}$$

is a partial derivative of a hole Fermi potential with respect to the spatial x-axis, k_{B} is the Boltzmann constant, T is the temperature,

$$\frac{\partial p}{\partial x}$$

is a partial derivative of the hole concentration with respect to the spatial x-axis,

$$\frac{\partial p}{\partial t}$$

is a partial derivative of the hole concentration with respect to the time,

$$\frac{\partial {J}_{p}}{\partial x}$$

is a partial derivative of the hole current density with respect to the spatial x-axis, G is the carrier generation rate, and R is the carrier recombination rate.

A cation drift-diffusion equation is expressed as Equation (6).

$${J}_{c} = q {μ}_{c} ( - c \frac{\partial {φ}_{c}}{\partial x} - {k}_{B} T \frac{\partial c}{\partial x} ) \qquad ( 6 )$$

A cation current continuity equation is expressed as Equation (7).

$$\frac{\partial c}{\partial t} = - \frac{1}{q} \frac{\partial {J}_{c}}{\partial x} \qquad ( 7 )$$

In equations (6) and (7), J_{c} is a cation current density, q is the unit charge, μ_{c} is a cation mobility, c is the cation concentration,

$$\frac{\partial {φ}_{c}}{\partial x}$$

is a partial derivative of a cation electrostatic potential with respect to the spatial x-axis, k_{B} is the Boltzmann constant, T is the temperature,

$$\frac{\partial c}{\partial x}$$

is a partial derivative of the cation concentration with respect to the spatial x-axis,

$$\frac{\partial c}{\partial t}$$

is a partial derivative of the cation concentration with respect to the time, and

$$\frac{\partial {J}_{c}}{\partial x}$$

is a partial derivative of the cation current density with respect to the spatial x-axis.

An anion drift-diffusion equation is expressed as Equation (8).

$${J}_{a} = q {μ}_{a} ( - a \frac{\partial {φ}_{a}}{\partial x} + {k}_{B} T \frac{\partial a}{\partial x} ) \qquad ( 8 )$$

An anion current continuity equation is expressed as Equation (9).

$$\frac{\partial a}{\partial t} = \frac{1}{q} \frac{\partial {J}_{a}}{\partial x} \qquad ( 9 )$$

In equations (8) and (9), Jₐ is an anion current density, q is the unit charge, μₐ is an anion mobility, a is the anion concentration,

$$\frac{\partial {φ}_{a}}{\partial x}$$

is a partial derivative of an anion electrostatic potential with respect to the spatial x-axis, k_{B} is the Boltzmann constant, T is the temperature,

$$\frac{\partial a}{\partial x}$$

is a partial derivative of the anion concentration with respect to the spatial x-axis,

$$\frac{\partial a}{\partial t}$$

is a partial derivative of the anion concentration with respect to the time, and

$$\frac{\partial {J}_{a}}{\partial x}$$

is a partial derivative of the anion current density with respect to the spatial x-axis.

The solar cell drift-diffusion model is solved using a Scharfetter-Gummel discretization, expressed as Equations (10)-(14).

$$[ - 2 \times \frac{{ε}_{i + 1 / 2} + {ε}_{i - 1 / 2}}{2 Δ {x}^{2}} - \frac{{n}_{i}^{j} + {p}_{i}^{j}}{{k}_{B} T} ] {φ}_{i}^{j} + {ε}_{i + \frac{1}{2}} \frac{{φ}_{i + 1}^{j}}{Δ {x}^{2}} + {ε}_{i - \frac{1}{2}} \frac{{φ}_{i - 1}^{j}}{Δ {x}^{2}} = - q ( {p}_{i}^{j} - {n}_{i}^{j} + {N}_{D} - {N}_{A} + c - {N}_{c \_ static} - a + {N}_{{a}_{-} static} ) - \frac{{φ}_{i}^{j - 1} ( {n}_{i}^{j} + {p}_{i}^{j} )}{{k}_{B} T} \qquad ( 10 )$$

The equation (10) is a discrete form of Equation (1), where ε_{i+1/2} is a mean value of a dielectric constant at a spatial coordinate i and a dielectric constant at a spatial coordinate i+1, ε_{i-1/2} is a mean value of a dielectric constant at a spatial coordinate i−1 and the dielectric constant at the spatial coordinate i, Δx is a unit spatial step, nᵢ^{j} is an electron concentration at the spatial coordinate i and a time coordinate j, pᵢ^{j} is a hole concentration at the spatial coordinate i and the time coordinate j, k_{B} is the Boltzmann constant, T is the temperature, φᵢ^{j} is an electrostatic potential at the spatial coordinate i and the time coordinate j, φᵢ₊₁^{j} is an electrostatic potential at the spatial coordinate i+1 and the time coordinate j, φᵢ₋₁^{j} is an electrostatic potential at the spatial coordinate i−1 and the time coordinate j, q is the unit charge, c is the cation concentration, N_{c_static} is the cation vacancy, N_{c_static} is the anion vacancy, N_{A} is the doping acceptor concentration, and N_{D} is the doping donor concentration.

$$[ \frac{1}{Δ t} + \frac{{D}_{{n}_{i + 1 / 2}}}{Δ {x}^{2}} B ( \frac{{φ}_{n , i} - {φ}_{n , i + 1}}{{k}_{B} T} ) + \frac{{D}_{{n}_{i - 1 / 2}}}{Δ {x}^{2}} B ( \frac{{φ}_{n , i} - {φ}_{n , i - 1}}{{k}_{B} T} ) + {k}_{r a d} {p}_{i}^{j - 1} + \frac{{p}_{i}^{j - 1}}{{τ}_{n} ( {p}_{i}^{j - 1} + {p}_{t} ) + {τ}_{p} ( {n}_{i}^{j - 1} + {n}_{t} )} ] {n}_{i}^{j} - [ \frac{{D}_{{n}_{i + 1 / 2}}}{Δ {x}^{2}} B ( \frac{{φ}_{n , i + 1} - {φ}_{n , i}}{{k}_{B} T} ) ] {n}_{i + 1}^{j} - [ \frac{{D}_{{n}_{i - 1 / 2}}}{Δ {x}^{2}} B ( \frac{{φ}_{n , i - 1} - {φ}_{n , i}}{{k}_{B} T} ) ] {n}_{i - 1}^{j} = \frac{{n}_{i}^{j - 1}}{Δ t} + {G}_{i} - \frac{{n}_{in}^{2}}{{τ}_{n} ( {p}_{i}^{j - 1} + {p}_{t} ) + {τ}_{p} ( {n}_{i}^{j - 1} + {n}_{t} )} - {k}_{r a d} {n}_{in}^{2} \qquad ( 11 )$$

The equation (11) is a discrete form of a combination of equation (2) and equation (3), where Δt is a unit time step, Dₙ_{_{i+1/2}} is a mean value of an electron diffusion coefficient at the spatial coordinate i and an electron diffusion coefficient at the spatial coordinate i+1,

$$B ( \frac{{φ}_{n , i} - {φ}_{n , i + 1}}{{k}_{B} T} )$$

is a Bernoulli's equation with a variable

$$\frac{{φ}_{n , i} - {φ}_{n , i + 1}}{{k}_{B} T} ,$$

φ_{n,i} is an electron Fermi potential at the spatial coordinate i, φ_{n,i+1} is an electron Fermi potential at the spatial coordinate i+1, Dₙ_{_{i−1/2}} is a mean value of an electron diffusion coefficient at the spatial coordinate i−1 and the electron diffusion coefficient at the spatial coordinate i,

$$B ( \frac{{φ}_{n , i} - {φ}_{n , i - 1}}{{k}_{B} T} )$$

is a Bernoulli's equation with a variable

$$\frac{{φ}_{n , i} - {ϕ}_{n , i - 1}}{{k}_{B} T} ,$$

φ_{n,i-1} is an electron Fermi potential at the spatial coordinate i−1, k_{rad} is a radiation recombination coefficient, τₙ is a minority electron lifetime, pₜ is a defect hole concentration, τₚ is a minority hole lifetime, nₜ is a defect electron concentration, pᵢ^{j-1} is a hole concentration at the spatial coordinate i and a time coordinate j−1, nᵢ^{j} is the electron concentration at the spatial coordinate i and the time coordinate j,

$$B ( \frac{{φ}_{n , i + 1} - {φ}_{n , i}}{{k}_{B} T} )$$

is a Bernoulli's equation with a variable

$$\frac{{φ}_{n , i + 1} - {φ}_{n , i}}{{k}_{B} T} ,$$

nᵢ₊₁^{j} is an electron concentration at the spatial coordinate i+1 and the time coordinate j,

$$B ( \frac{{φ}_{n , i - 1} - {φ}_{n , i}}{{k}_{B} T} )$$

is a Bernoulli's equation with a variable

$$\frac{{φ}_{n , i - 1} - {φ}_{n , i}}{{k}_{B} T} ,$$

nᵢ₋₁^{j} is an electron concentration at the spatial coordinate i−1 and the time coordinate j, nᵢ^{j-1} is an electron concentration at the spatial coordinate i and the time coordinate j−1, Gᵢ is a carrier generation rate at the spatial coordinate i, and nᵢₙ² is a square of an intrinsic carrier concentration.

$$[ \frac{1}{Δ t} + \frac{{D}_{{p}_{i + 1 / 2}}}{Δ {x}^{2}} B ( - \frac{{φ}_{p , i} - {φ}_{p , i + 1}}{{k}_{B} T} ) + \frac{{D}_{{p}_{i - 1 / 2}}}{Δ {x}^{2}} B ( - \frac{{φ}_{p , i} - {φ}_{p , i - 1}}{{k}_{B} T} ) + {k}_{rad} {n}_{i}^{j - 1} + \frac{{n}_{i}^{j - 1}}{{τ}_{n} ( {p}_{i}^{j - 1} + {p}_{t} ) + {τ}_{p} ( {n}_{i}^{j - 1} + {n}_{t} )} ] {p}_{i}^{j} - [ \frac{{D}_{{p}_{i + 1 / 2}}}{Δ {x}^{2}} B ( - \frac{{φ}_{p , i + 1} - {φ}_{p , i}}{{k}_{B} T} ) ] {p}_{i + 1}^{j} - [ \frac{{D}_{{p}_{i + 1 / 2}}}{Δ {x}^{2}} B ( - \frac{{φ}_{p , i - 1} - {φ}_{p , i}}{{k}_{B} T} ) ] {p}_{i - 1}^{j} = \frac{{p}_{i}^{j - 1}}{Δ t} + {G}_{i} - \frac{{n}_{in}^{2}}{{τ}_{n} ( {p}_{i}^{j - 1} + {p}_{t} ) + {τ}_{p} ( {n}_{i}^{j - 1} + {n}_{t} )} - {k}_{rad} {n}_{in}^{2} \qquad ( 12 )$$

The equation (12) is a discrete form of a combination of equation (4) and equation (5), where Δt is the unit time step, Dₚ_{_{i+1/2}} is a mean value of a hole diffusion coefficient at the spatial coordinate i and a hole diffusion coefficient at the spatial coordinate i+1,

$$B ( - \frac{{φ}_{p , i} - {φ}_{p , i + 1}}{{k}_{B} T} )$$

is a Bernoulli's equation with a variable

$$- \frac{{φ}_{p , i} - {φ}_{p , i + 1}}{{k}_{B} T} ,$$

φ_{p,i} is a hole Fermi potential at the spatial coordinate i, φ_{p,i+1} is a hole Fermi potential at the spatial coordinate i+1, Dₚ_{_{i−1/2}} is a mean value of a hole diffusion coefficient at the spatial coordinate i−1 and the hole diffusion coefficient at the spatial coordinate i,

$$B ( - \frac{{φ}_{p , i} - {φ}_{p , i - 1}}{{k}_{B} T} )$$

is a Bernoulli's equation with a variable

$$- \frac{{φ}_{p , i} - {φ}_{p , i - 1}}{{k}_{B} T} ,$$

φ_{p,i-1} is a hole Fermi potential at the spatial coordinate i−1, k_{rad} is the radiation recombination coefficient, nᵢ^{j-1} is the electron concentration at the spatial coordinate i and the time coordinate j−1, τₙ is the minority electron lifetime, pₜ is the defect hole concentration, τₚ is the minority hole lifetime, nₜ is the defect electron concentration, pᵢ^{j} is the hole concentration at the spatial coordinate i and the time coordinate j,

$$B ( - \frac{{φ}_{p , i + 1} - {φ}_{p , i}}{{k}_{B} T} )$$

is a Bernoulli's equation with a variable

$$- \frac{{φ}_{p , i + 1} - {φ}_{p , i}}{{k}_{B} T} ,$$

pᵢ₊₁^{j} is a hole concentration at the spatial coordinate i+1 and the time coordinate j,

$$B ( - \frac{{φ}_{p , i - 1} - {φ}_{p , i}}{{k}_{B} T} )$$

is a Bernoulli's equation with a variable

$$- \frac{{φ}_{p , i - 1} - {φ}_{p , i}}{{k}_{B} T} ,$$

pᵢ₋₁^{j} is a hole concentration at the spatial coordinate i−1 and the time coordinate j, pᵢ^{j-1} is the hole concentration at the spatial coordinate i and the time coordinate j−1, Gᵢ is the carrier generation rate at the spatial coordinate i, and nᵢₙ² is the square of the intrinsic carrier concentration.

$$[ \frac{1}{Δ t} + \frac{{D}_{{c}_{i + 1 / 2}}}{Δ {x}^{2}} B ( - \frac{{φ}_{c , i} - {φ}_{c , i + 1}}{{k}_{B} T} ) + \frac{{D}_{{c}_{i - 1 / 2}}}{Δ {x}^{2}} B ( - \frac{{φ}_{c , i} - {φ}_{c , i - 1}}{{k}_{B} T} ) ] {c}_{i}^{j} - [ \frac{{D}_{{c}_{i + 1 / 2}}}{Δ {x}^{2}} B ( - \frac{{φ}_{c , i + 1} - {φ}_{c , i}}{{k}_{B} T} ) ] {c}_{i + 1}^{j} - [ \frac{{D}_{{c}_{i - 1 / 2}}}{Δ {x}^{2}} B ( - \frac{{φ}_{c , i - 1} - {φ}_{c , i}}{{k}_{B} T} ) ] {c}_{i - 1}^{j} = \frac{{c}_{i}^{j - 1}}{Δ t} \qquad ( 13 )$$

Equation (13) is a discrete form of a combination of equation (6) and equation (7), where Δt is the unit time step, D_{c}_{_{i+1/2}} is a mean value of a cation diffusion coefficient at the spatial coordinate i and a cation diffusion coefficient at the spatial coordinate i+1,

$$B ( - \frac{{φ}_{c , i} - {φ}_{c , i + 1}}{{k}_{B} T} )$$

is a Bernoulli's equation with a variable

$$- \frac{{φ}_{c , i} - {φ}_{c , i + 1}}{{k}_{B} T} ,$$

φ_{c,i} is a cation electrostatic potential at the spatial coordinate i, φ_{c,i+1} is a cation electrostatic potential at the spatial coordinate i+1, D_{c}_{_{i−1/2}} is a mean value of a cation diffusion coefficient at the spatial coordinate i−1 and the cation diffusion coefficient at the spatial coordinate i,

$$\\ B ( - \frac{{φ}_{c , i} - {φ}_{c , i - 1}}{{k}_{B} T} )$$

is a Bernoulli's equation with a variable

$$\\ - \frac{{φ}_{c , i} - {φ}_{c , i - 1}}{{k}_{B} T} ,$$

φ_{c,i-1} is a cation electrostatic potential at the spatial coordinate i−1, cᵢ^{j} is a cation concentration at the spatial coordinate i and the time coordinate j,

$$\\ B ( - \frac{{φ}_{c , i + 1} - {φ}_{c , i}}{{k}_{B} T} )$$

is a Bernoulli's equation with a variable

$$\\ - \frac{{φ}_{c , i + 1} - {φ}_{c , i}}{{k}_{B} T} ,$$

cᵢ₊₁^{j} is a cation concentration at the spatial coordinate i+1 and the time coordinate j,

$$\\ B ( - \frac{{φ}_{c , i - 1} - {φ}_{c , i}}{{k}_{B} T} )$$

is a Bernoulli's equation with a variable

$$\\ - \frac{{φ}_{c , i - 1} - {φ}_{c , i}}{{k}_{B} T} ,$$

cᵢ₋₁^{j} is a cation concentration at the spatial coordinate i−1 and the time coordinate j, and cᵢ^{j-1} is a cation concentration at the spatial coordinate i and the time coordinate j−1.

$$\\ \begin{matrix}[ \frac{1}{Δ t} + \frac{{D}_{{a}_{i + 1 / 2}}}{Δ {x}^{{}_{} 2}} B ( \frac{{φ}_{a , i} - {φ}_{a , i + 1}}{{k}_{B} T} ) + \frac{{D}_{{a}_{i - 1 / 2}}}{Δ {x}^{{}_{} 2}} B ( \frac{{φ}_{a , i} - {φ}_{a , i - 1}}{{k}_{B} T} ) ] {a}_{i}^{{}_{} j} - [ \frac{{D}_{{a}_{i + 1 / 2}}}{Δ {x}^{{}_{} 2}} B ( \frac{{φ}_{a , i + 1} - {φ}_{a , i}}{{k}_{B} T} ) ] {a}_{i + 1}^{{}_{} j} - [ \frac{{D}_{{a}_{i - 1 / 2}}}{Δ {x}^{{}_{} 2}} B ( \frac{{φ}_{a , i - 1} - {φ}_{a , i}}{{k}_{B} T} ) ] {a}_{i - 1}^{{}_{} j} = \frac{{a}_{i}^{{}_{} j - 1}}{Δ t} & ( 14 )\end{matrix}$$

Equation (14) is a discrete form of a combination of equation (8) and equation (9), where Δt is the unit time step, Dₐ_{_{i−1/2}} is a mean value of an anion diffusion coefficient at the spatial coordinate i and an anion diffusion coefficient at the spatial coordinate i+1,

$$\\ B ( \frac{{φ}_{a , i} - {φ}_{a , i + 1}}{{k}_{B} T} )$$

is a Bernoulli's equation with a variable

$$\\ \frac{{φ}_{a , i} - {φ}_{a , i + 1}}{{k}_{B} T} ,$$

φ_{a,i} is an anion electrostatic potential at the spatial coordinate i, φ_{a,i+1} is an anion electrostatic potential at the spatial coordinate i+1, Dₐ_{_{i−1/2}} is a mean value of an anion diffusion coefficient at the spatial coordinate i−1 and the anion diffusion coefficient at the spatial coordinate i,

$$\\ B ( \frac{{φ}_{a , i} - {φ}_{a , i - 1}}{{k}_{B} T} )$$

is a Bernoulli's equation with a variable

$$\\ \frac{{φ}_{a , i} - {φ}_{a , i - 1}}{{k}_{B} T} ,$$

φ_{a,i-1} is an anion electrostatic potential at the spatial coordinate i−1, aᵢ^{j} is an anion concentration at the spatial coordinate i and the time coordinate j,

$$\\ B ( \frac{{φ}_{a , i + 1} - {φ}_{a , i}}{{k}_{B} T} )$$

is a Bernoulli's equation with a variable

$$\\ \frac{{φ}_{a , i + 1} - {φ}_{a , i}}{{k}_{B} T} ,$$

aᵢ₊₁^{j} an is an anion concentration at the spatial coordinate i+1 and the time coordinate j,

$$\\ B ( \frac{{φ}_{a , i - 1} - {φ}_{a , i}}{{k}_{B} T} )$$

is a Bernoulli's equation with a variable

$$\\ \frac{{φ}_{a , i - 1} - {φ}_{a , i}}{{k}_{B} T} ,$$

aᵢ₋₁^{j} is an anion concentration at the spatial coordinate i−1 and the time coordinate j, and aᵢ^{j-1} is an anion concentration at the spatial coordinate i and the time coordinate j−1.

(S2) The solar cell is subjected to forward voltage scan to obtain a forward JV curve. The solar cell is subjected to reverse voltage scan to obtain a reverse JV curve. Whether a JV curve type of the solar cell is the type A, the type B, the type C or the type D is determined according to the forward JV curve and the reverse JV curve, as shown in FIG. 1.

TABLE 1
Forward-reverse JV curves of types A, B, C and D

| Hysteresis | | |
|---|---|---|
| Type | Description | Diagnostic conclusion |
| A | There is a small difference in open | There are a large number of bulk defects or |
| | circuit voltage (Voc) and short circuit | both a large number of bulk defects and a |
| | current (Jsc) between the forward JV | large number of surface defects in the |
| | curve and the reverse JV curve, and a | active layer of the solar cell. |
| | photocurrent of the reverse JV curve | |
| | is greater than that of the forward JV | |
| | curve. | |
| B | There is no difference in Jsc between | There are a large number of surface defects |
| | the forward JV curve and the | in the active layer of the solar cell. |
| | reverse JV curve, only the Voc. | |
| C | The forward JV curve and the reverse | There are a large number of bulk defects |
| | JV curve have a low fill factor (FF), | in the active layer of the solar cell. |
| | and there is no difference in Voc | |
| | between the forward JV curve and the | |
| | reverse JV curve but there is a large | |
| | difference in Jsc. | |
| D | The forward JV curve and the reverse | There are bulk defects and surface defects |
| | JV curve have a low FF, and there is a | in the active layer of the solar cell. |
| | large difference in Jsc and a small | |
| | difference in Voc between the forward | |
| | JV curve and the reverse JV curve. | |

In the step (S2), if the JV curve type of the solar cell is the type B, the internal loss mechanism is determined as the surface defect of the active layer.

If the JV curve type of the solar cell is the type A, the internal loss mechanism is determined as the bulk defect of the active layer or a combination of the bulk defect and the surface defect of the active layer. In this case, the voltage scan rate is increased, and the step (S2) is repeated until the JV curve type of the solar cell is the type C or the type D.

If the JV curve type of the solar cell is the type C, the internal loss mechanism is determined as the bulk defect of the active layer.

If the JV curve type of the solar cell is the type D, the internal loss mechanism is determined as the combination of the bulk defect and the surface defect of the active layer.

### EMBODIMENT 1

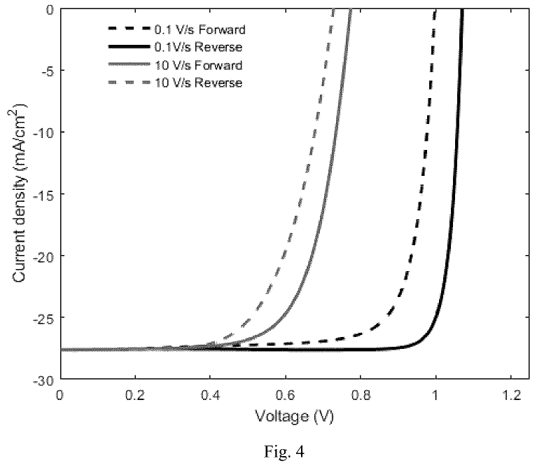

As shown in FIG. 4, it is observed that a JV curve type of a solar cell is type B. In this case, an internal loss mechanism of the solar cell is determined as a surface defect of an active layer. The result of Embodiment 1, that is, the JV curve corresponding to the surface defect, is obtained under conditions that the active layer has a bulk carrier lifetime of 1 μs and a surface carrier lifetime of 1 ns.

### EMBODIMENT 2

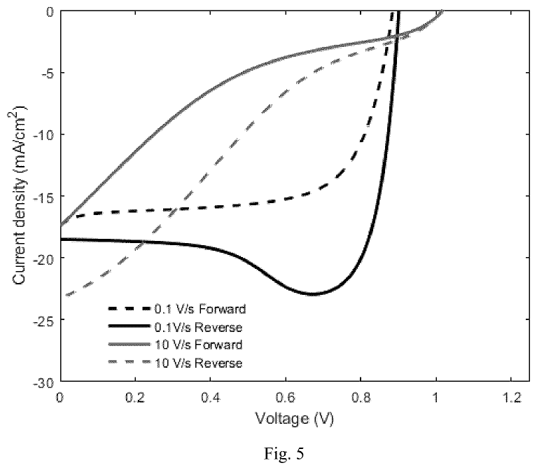

As shown in FIG. 5, it is observed that a JV curve type of a solar cell is type A at a low scanning speed and type C at a high scanning speed. In this case, an internal loss mechanism of the solar cell is determined as a bulk defect of an active layer. The result of Embodiment 2, that is, the JV curve corresponding to the bulk defect, is obtained under conditions that the active layer has a bulk carrier lifetime of 1 μs and a surface carrier lifetime of 1 ns.

### EMBODIMENT 3

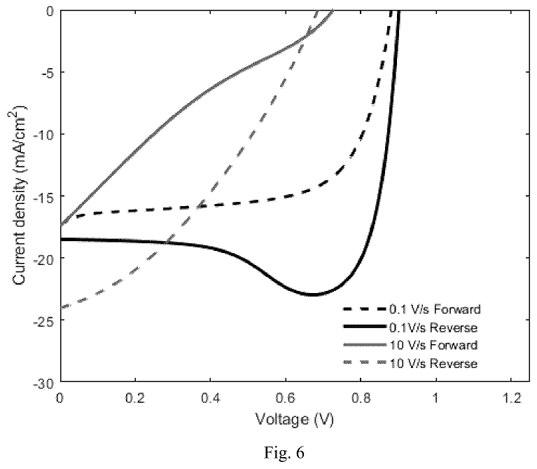

As shown in FIG. 6, it is observed that a JV curve type of a solar cell is type A at a low scanning speed and type D at a high scanning speed. In this case, an internal loss mechanism of the solar cell is determined as a combination of a bulk defect and a surface defect of an active layer. The result of Embodiment 3, that is, the JV curve corresponding to the combination of the bulk defect and the surface defect, is obtained under conditions that the active layer has a bulk carrier lifetime of 1 μs and a surface carrier lifetime of 1 ns.

Therefore, the method of the present disclosure adopts the analysis according to the types of simulated JV curves, so as to diagnose a corresponding internal loss mechanism of the solar cell.

It should be noted that the embodiments described above are merely intended to illustrate the technical solutions of the present disclosure, and are not intended to limit the scope of the disclosure. Although the present disclosure is described in detail with reference to the embodiments, it should be understood that modifications or equivalent substitutions made by those of ordinary skill in the art without departing from the spirit of the present disclosure shall fall within the scope of the present disclosure defined by the appended claims.

What is claimed is:

1. A method for diagnosing an internal loss mechanism of a solar cell, the solar cell comprising an anode and a cathode; an electron transport layer, an active layer and a hole transport layer being arranged in sequence from top to bottom between the cathode and the anode; and the method comprising:
(S1) modeling the solar cell through a solar cell multi-physics simulation platform, and simulating current density-voltage (JV) curves respectively of type A, type B, type C and type D by regulating a bulk defect and a surface defect of the active layer and a voltage scan rate; and
(S2) subjecting the solar cell to forward voltage scan to obtain a forward JV curve; subjecting the solar cell to reverse voltage scan to obtain a reverse JV curve; and determining whether a JV curve type of the solar cell is the type A, the type B, the type C or the type D based on the forward JV curve and the reverse JV curve;
wherein the solar cell multi-physics simulation platform is configured to model the solar cell by solving a solar cell drift-diffusion model with ion migration, expressed as:
$${ε}_{0} {ε}_{r} \frac{{\partial }^{2} φ}{\partial {x}^{2}} = - q ( p - n + c - {N}_{c \_ static} - a + {N}_{a \_ static} + {N}_{A} - {N}_{D} ) ; \qquad ( 1 )$$
wherein equation (1) is a Poisson equation, ε₀ is a vacuum dielectric constant, εᵣ, is a relative dielectric constant,
$$\frac{{\partial }^{2} φ}{\partial {x}^{2}}$$
is a second-order partial derivative of an electrostatic potential with respect to a spatial x-axis, p is a hole concentration, n is an electron concentration, q is a unit charge, c is a cation concentration, N_{c_static} is a cation vacancy, a is an anion concentration, N_{a_static} is an anion vacancy, N_{A} is a doping acceptor concentration, and N_{D} is a doping donor concentration;
an electron drift-diffusion equation is expressed as equation (2):
$${J}_{n} = q {μ}_{n} ( - n \frac{\partial {φ}_{n}}{\partial x} + {k}_{B} T \frac{\partial n}{\partial x} ) ; \qquad ( 2 )$$
an electron current continuity equation is expressed as equation (3):
$$\frac{\partial n}{\partial t} = \frac{1}{q} \frac{\partial {J}_{n}}{\partial x} + G - R ; \qquad ( 3 )$$
wherein in equations (2) and (3), Jₙ is an electron current density, q is the unit charge, μₙ is an electron mobility, n is the electron concentration,
$$\frac{\partial {φ}_{n}}{\partial x}$$
is a partial derivative of an electron Fermi potential with respect to the spatial x-axis, k_{B} is a Boltzmann constant, T is temperature,
$$\frac{\partial n}{\partial x}$$
is a partial derivative of the electron concentration with respect to the spatial x-axis,
$$\frac{\partial n}{\partial t}$$
is a partial derivative of the electron concentration with respect to time,
$$\frac{\partial {J}_{n}}{\partial x}$$
is a partial derivative of the electron current density with respect to the spatial x-axis, G is a carrier generation rate, and R is a carrier recombination rate;
a hole drift-diffusion equation is expressed as equation (4):
$${J}_{p} = q {μ}_{p} ( - p \frac{\partial {φ}_{p}}{\partial x} - {k}_{B} T \frac{\partial p}{\partial x} ) ; \qquad ( 4 )$$
a hole current continuity equation is expressed as equation (5):
$$\\ \begin{matrix}\frac{\partial p}{\partial t} = \frac{1}{q} \frac{\partial {J}_{p}}{\partial x} + G - R ; & ( 5 )\end{matrix}$$
wherein in equations (4) and (5), Jₚ is a hole current density, q is the unit charge, μₚ is a hole mobility, p is the hole concentration,
$$\\ \frac{\partial {φ}_{p}}{\partial x}$$
is a partial derivative of a hole Fermi potential with respect to the spatial x-axis, k_{B} is the Boltzmann constant, T is the temperature,
$$\\ \frac{\partial p}{\partial x}$$
is a partial derivative of the hole concentration with respect to the spatial x-axis,
$$\\ \frac{\partial p}{\partial t}$$
is a partial derivative of the hole concentration with respect to the time,
$$\\ \frac{\partial {J}_{p}}{\partial x}$$
is a partial derivative of the hole current density with respect to the spatial x-axis, G is the carrier generation rate, and R is the carrier recombination rate;
a cation drift-diffusion equation is expressed as equation (6):
$$\\ \begin{matrix}{J}_{c} = q {μ}_{c} ( - c \frac{\partial {φ}_{c}}{\partial x} - {k}_{B} T \frac{\partial c}{\partial x} ) ; & ( 6 )\end{matrix}$$
a cation current continuity equation is expressed as equation (7):
$$\\ \begin{matrix}\frac{\partial c}{\partial t} = - \frac{1}{q} \frac{\partial {J}_{c}}{\partial x} ; & ( 7 )\end{matrix}$$
wherein in equations (6) and (7), J_{c} is a cation current density, q is the unit charge, μ_{c} is a cation mobility, c is the cation concentration,
$$\\ \frac{\partial {φ}_{c}}{\partial x}$$
is a partial derivative of a cation electrostatic potential with respect to the spatial x-axis, k_{B} is the Boltzmann constant, T is the temperature,
$$\\ \frac{\partial c}{\partial x}$$
is a partial derivative of the cation concentration with respect to the spatial x-axis,
$$\\ \frac{\partial c}{\partial t}$$
is a partial derivative of the cation concentration with respect to the time, and
$$\\ \frac{\partial {J}_{c}}{\partial x}$$
is a partial derivative of the cation current density with respect to the spatial x-axis;
an anion drift-diffusion equation is expressed as equation (8):
$$\\ \begin{matrix}{J}_{a} = q {μ}_{a} ( - a \frac{\partial {φ}_{a}}{\partial x} + {k}_{B} T \frac{\partial a}{\partial x} ) ; & ( 8 )\end{matrix}$$
an anion current continuity equation is expressed as equation (9):
$$\\ \begin{matrix}\frac{\partial a}{\partial t} = - \frac{1}{q} \frac{\partial {J}_{a}}{\partial x} ; & ( 9 )\end{matrix}$$
wherein in equations (8) and (9), Jₐ is an anion current density, q is the unit charge, μₐ is an anion mobility, a is the anion concentration,
$$\\ \frac{\partial {φ}_{a}}{\partial x}$$
is a partial derivative of an anion electrostatic potential with respect to the spatial x-axis, k_{B} is the Boltzmann constant, T is the temperature,
$$\\ \frac{\partial a}{\partial x}$$
is a partial derivative of the anion concentration with respect to the spatial x-axis,
$$\frac{\partial a}{\partial t}$$
is a partial derivative of the anion concentration with respect to the time, and
$$\frac{\partial {J}_{a}}{\partial x}$$
is a partial derivative of the anion current density with respect to the spatial x-axis.

2. The method of claim 1, wherein the solar cell drift-diffusion model is solved using a Scharfetter-Gummel discretization, expressed as equations (10)-(14):
$$[ - 2 \times \frac{{ε}_{i + 1 / 2} + {ε}_{i - 1 / 2}}{2 Δ {x}^{2}} - \frac{{n}_{i}^{j} + {p}_{i}^{j}}{{k}_{B} T} ] {φ}_{i}^{j} + {ε}_{i + \frac{1}{2}} \frac{{φ}_{i + 1}^{j}}{Δ {x}^{2}} + {ε}_{i - \frac{1}{2}} \frac{{φ}_{i - 1}^{j}}{Δ {x}^{2}} = - q ( {p}_{i}^{j} - {n}_{i}^{j} + {N}_{D} - {N}_{A} + c - {N}_{c \_ static} - a + {N}_{a \_ static} ) - \frac{{φ}_{i}^{j - 1} ( {n}_{i}^{j} + {p}_{i}^{j} )}{{k}_{B} T} ; \qquad ( 10 )$$
wherein the equation (10) is a discrete form of the equation (1), ε_{i+1/2} is a mean value of a dielectric constant at a spatial coordinate i and a dielectric constant at a spatial coordinate i+1, ε_{i-1/2} is a mean value of a dielectric constant at a spatial coordinate i−1 and the dielectric constant at the spatial coordinate i, Δx is a unit spatial step, nᵢ^{j} is an electron concentration at the spatial coordinate i and a time coordinate j, pᵢ^{j} is a hole concentration at the spatial coordinate i and the time coordinate j, k_{B} is the Boltzmann constant, T is the temperature, φᵢ^{j} is an electrostatic potential at the spatial coordinate i and the time coordinate j, φᵢ₊₁^{j} is an electrostatic potential at the spatial coordinate i+1 and the time coordinate j, φᵢ₋₁^{j} is an electrostatic potential at the spatial coordinate i−1 and the time coordinate j, q is the unit charge, c is the cation concentration, N_{c_static} is the cation vacancy, N_{a_static} is the anion vacancy, N_{A} is the doping acceptor concentration, and N_{D} is the doping donor concentration;
$$[ \frac{1}{Δ t} + \frac{{D}_{{n}_{i + 1 / 2}}}{Δ {x}^{2}} B ( \frac{{φ}_{n , i} - {φ}_{n , i + 1}}{{k}_{B} T} ) + \frac{{D}_{{n}_{i - 1 / 2}}}{Δ {x}^{2}} B ( \frac{{φ}_{n , i} - {φ}_{n , i - 1}}{{k}_{B} T} ) + {k}_{rad} {p}_{i}^{j - 1} + \frac{{p}_{i}^{j - 1}}{{τ}_{n} ( {p}_{i}^{j - 1} + {p}_{t} ) + {τ}_{p} ( {n}_{i}^{j - 1} + {n}_{t} )} ] {n}_{i}^{j} - [ \frac{{D}_{{n}_{i + 1 / 2}}}{Δ {x}^{2}} B ( \frac{{φ}_{n , i + 1} - {φ}_{n , i}}{{k}_{B} T} ) ] {n}_{i + 1}^{j} - [ \frac{{D}_{{n}_{i - 1 / 2}}}{Δ {x}^{2}} B ( \frac{{φ}_{n , i - 1} - {φ}_{n , i}}{{k}_{B} T} ) ] {n}_{i - 1}^{j} = \frac{{n}_{i}^{j - 1}}{Δ t} + {G}_{i} - \frac{{n}_{in}^{2}}{{τ}_{n} ( {p}_{i}^{j - 1} + {p}_{t} ) + {τ}_{p} ( {n}_{i}^{j - 1} + {n}_{t} )} - {k}_{rad} {n}_{in}^{2} ; \qquad ( 11 )$$
wherein the equation (11) is a discrete form of a combination of the equation (2) and the equation (3), Δt is a unit time step, Dₙ_{_{i+1/2}} is a mean value of an electron diffusion coefficient at the spatial coordinate i and an electron diffusion coefficient at the spatial coordinate i+1,
$$B ( \frac{{φ}_{n , i} - {φ}_{n , i + 1}}{{k}_{B} T} )$$
is a Bernoulli's equation with a variable
$$\frac{{φ}_{n , i} - {φ}_{n , i + 1}}{{k}_{B} T} ,$$
φ_{n,i} is an electron Fermi potential at the spatial coordinate i, φ_{n,i+1} is an electron Fermi potential at the spatial coordinate i+1, Dₙ_{_{i−1/2}} is a mean value of an electron diffusion coefficient at the spatial coordinate i−1 and the electron diffusion coefficient at the spatial coordinate i,
$$B ( \frac{{φ}_{n , i} - {φ}_{n , i - 1}}{{k}_{B} T} )$$
is a Bernoulli's equation with a variable
$$\frac{{φ}_{n , i} - {φ}_{n , i - 1}}{{k}_{B} T} ,$$
φ_{n,i-1} is an electron Fermi potential at the spatial coordinate i−1, k_{rad} is a radiation recombination coefficient, τₙ is a minority electron lifetime, pₜ is a defect hole concentration, τₚ is a minority hole lifetime, nₜ is a defect electron concentration, pᵢ^{j-1} is a hole concentration at the spatial coordinate i and a time coordinate j−1, nᵢ^{j} is the electron concentration at the spatial coordinate i and the time coordinate j,
$$B ( \frac{{φ}_{n , i + 1} - {φ}_{n , i}}{{k}_{B} T} )$$
is a Bernoulli's equation with a variable
$$\frac{{φ}_{n , i + 1} - {φ}_{n , i}}{{k}_{B} T} ,$$
nᵢ₊₁^{j} is an electron concentration at the spatial coordinate i+1 and the time coordinate j,
$$B ( \frac{{φ}_{n , i - 1} - {φ}_{n , i}}{{k}_{B} T} )$$
is a Bernoulli's equation with a variable
$$\frac{{φ}_{n , i - 1} - {φ}_{n , i}}{{k}_{B} T} ,$$
nᵢ₋₁^{j} is an electron concentration at the spatial coordinate i−1 and the time coordinate j, nᵢ^{j-1} is an electron concentration at the spatial coordinate i and the time coordinate j−1, Gᵢ is a carrier generation rate at the spatial coordinate i, and nᵢₙ² is a square of an intrinsic carrier concentration;
$$[ \frac{1}{Δ t} + \frac{{D}_{{p}_{i + 1 / 2}}}{Δ {x}^{2}} B ( - \frac{{φ}_{p , i} - {φ}_{p , i + 1}}{{k}_{B} T} ) + \frac{{D}_{{p}_{i - 1 / 2}}}{Δ {x}^{2}} B ( - \frac{{φ}_{p , i} - {φ}_{p , i - 1}}{{k}_{B} T} ) + {k}_{rad} {n}_{i}^{j - 1} + \frac{{n}_{i}^{j - 1}}{{τ}_{n} ( {p}_{i}^{j - 1} + {p}_{t} ) + {τ}_{p} ( {n}_{i}^{j - 1} + {n}_{t} )} ] {p}_{i}^{j} - [ \frac{{D}_{{p}_{i + 1 / 2}}}{Δ {x}^{2}} B ( - \frac{{φ}_{p , i + 1} - {φ}_{p , i}}{{k}_{B} T} ) ] {p}_{i + 1}^{j} - [ \frac{{D}_{{p}_{i - 1 / 2}}}{Δ {x}^{2}} B ( - \frac{{φ}_{p , i - 1} - {φ}_{p , i}}{{k}_{B} T} ) ] {p}_{i - 1}^{j} = \frac{{p}_{i}^{j - 1}}{Δ t} + {G}_{i} - \frac{{n}_{in}^{2}}{{τ}_{n} ( {p}_{i}^{j - 1} + {p}_{t} ) + {τ}_{p} ( {n}_{i}^{j - 1} + {n}_{t} )} - {k}_{rad} {n}_{in}^{2} ; \qquad ( 12 )$$
wherein the equation (12) is a discrete form of a combination of the equation (4) and the equation (5), Δt is the unit time step, Dₚ_{_{i+1/2}} is a mean value of a hole diffusion coefficient at the spatial coordinate i and a hole diffusion coefficient at the spatial coordinate i+1,
$$B ( - \frac{{φ}_{p , i} - {φ}_{p , i + 1}}{{k}_{B} T} )$$
is a Bernoulli' s equation with a variable
$$- \frac{{φ}_{p , i} - {φ}_{p , i + 1}}{{k}_{B} T} ,$$
φ_{p,i} is a hole Fermi potential at the spatial coordinate i, φ_{p,i+1} is a hole Fermi potential at the spatial coordinate i+1, Dₚ_{_{i−1/2}} is a mean value of a hole diffusion coefficient at the spatial coordinate i−1 and the hole diffusion coefficient at the spatial coordinate i,
$$B ( - \frac{{φ}_{p , i} - {φ}_{p , i - 1}}{{k}_{B} T} )$$
is a Bernoulli's equation with a variable
$$- \frac{{φ}_{p , i} - {φ}_{p , i - 1}}{{k}_{B} T} ,$$
φ_{p,i-1} is a hole Fermi potential at the spatial coordinate i−1, k_{rad} is the radiation recombination coefficient, nᵢ^{j-1} is the electron concentration at the spatial coordinate i and the time coordinate j−1, τₙ is the minority electron lifetime, pₜ is the defect hole concentration, τₚ is the minority hole lifetime, nₜ is the defect electron concentration, pᵢ^{j} is the hole concentration at the spatial coordinate i and the time coordinate j,
$$B ( - \frac{{φ}_{p , i + 1} - {φ}_{p , i}}{{k}_{B} T} )$$
is a Bernoulli's equation with a variable
$$- \frac{{φ}_{p , i + 1} - {φ}_{p , i}}{{k}_{B} T} ,$$
pᵢ₊₁^{j} is a hole concentration at the spatial coordinate i+1 and the time coordinate j,
$$B ( - \frac{{φ}_{p , i - 1} - {φ}_{p , i}}{{k}_{B} T} )$$
is a Bernoulli's equation with a variable
$$- \frac{{φ}_{p , i - 1} - {φ}_{p , i}}{{k}_{B} T} ,$$
pᵢ₋₁^{j} is a hole concentration at the spatial coordinate i−1 and the time coordinate j, pᵢ^{j-1} is the hole concentration at the spatial coordinate i and the time coordinate j−1, Gᵢ is the carrier generation rate at the spatial coordinate i, and nᵢₙ² is the square of the intrinsic carrier concentration;
$$[ \frac{1}{Δ t} + \frac{{D}_{{c}_{i + 1 / 2}}}{Δ {x}^{2}} B ( - \frac{{φ}_{c , i} - {φ}_{c , i + 1}}{{k}_{B} T} ) + \frac{{D}_{{c}_{i - 1 / 2}}}{Δ {x}^{2}} B ( - \frac{{φ}_{c , i} - {φ}_{c , i - 1}}{{k}_{B} T} ) ] {c}_{i}^{j} - [ \frac{{D}_{{c}_{i + 1 / 2}}}{Δ {x}^{2}} B ( - \frac{{φ}_{c , i + 1} - {φ}_{c , i}}{{k}_{B} T} ) ] {c}_{i + 1}^{j} - [ \frac{{D}_{{c}_{i - 1 / 2}}}{Δ {x}^{2}} B ( - \frac{{φ}_{c , i - 1} - {φ}_{c , i}}{{k}_{B} T} ) ] {c}_{i - 1}^{j} = \frac{{c}_{i}^{j - 1}}{Δ t} ; \qquad ( 13 )$$
wherein the equation (13) is a discrete form of a combination of the equation (6) and the equation (7), Δt is the unit time step, D_{c}_{_{i+1/2}} is a mean value of a cation diffusion coefficient at the spatial coordinate i and a cation diffusion coefficient at the spatial coordinate i+1,
$$B ( - \frac{{φ}_{c , i} - {φ}_{c , i + 1}}{{k}_{B} T} )$$
is a Bernoulli's equation with a variable
$$- \frac{{φ}_{c , i} - {φ}_{c , i + 1}}{{k}_{B} T} ,$$
φ_{c,i} is a cation electrostatic potential at the spatial coordinate i, φ_{c,i+1} is a cation electrostatic potential at the spatial coordinate i+1, D_{c}_{_{i−1/2}} is a mean value of a cation diffusion coefficient at the spatial coordinate i−1 and the cation diffusion coefficient at the spatial coordinate i,
$$B ( - \frac{{φ}_{c , i} - {φ}_{c , i - 1}}{{k}_{B} T} )$$
is a Bernoulli's equation with a variable
$$- \frac{{φ}_{c , i} - {φ}_{c , i - 1}}{{k}_{B} T} ,$$
φ_{c,i-1} is a cation electrostatic potential at the spatial coordinate i−1, cᵢ^{j} is a cation concentration at the spatial coordinate i and the time coordinate j,
$$B ( - \frac{{φ}_{c , i + 1} - {φ}_{c , i}}{{k}_{B} T} )$$
is a Bernoulli's equation with a variable
$$- \frac{{φ}_{c , i + 1} - {φ}_{c , i}}{{k}_{B} T} ,$$
cᵢ₊₁^{j} is a cation concentration at the spatial coordinate i+1 and the time coordinate j,
$$B ( - \frac{{φ}_{c , i - 1} - {φ}_{c , i}}{{k}_{B} T} )$$
is a Bernoulli's equation with a variable
$$- \frac{{φ}_{c , i - 1} - {φ}_{c , i}}{{k}_{B} T} ,$$
cᵢ₋₁^{j} is a cation concentration at the spatial coordinate i−1 and the time coordinate j, and cᵢ^{j-1} is a cation concentration at the spatial coordinate i and the time coordinate j−1;
$$[ \frac{1}{Δ t} + \frac{{D}_{{a}_{i + 1 / 2}}}{Δ {x}^{2}} B ( \frac{{φ}_{a , i} - {φ}_{a , i + 1}}{{k}_{B} T} ) + \frac{{D}_{{a}_{i - 1 / 2}}}{Δ {x}^{2}} B ( \frac{{φ}_{a , i} - {φ}_{a , i - 1}}{{k}_{B} T} ) ] {a}_{i}^{j} - [ \text{} \frac{{D}_{{a}_{i + 1 / 2}}}{Δ {x}^{2}} B ( \frac{{φ}_{a , i + 1} - {φ}_{a , i}}{{k}_{B} T} ) ] {a}_{i + 1}^{j} - [ \frac{{D}_{{a}_{i - 1 / 2}}}{Δ {x}^{2}} B ( \frac{{φ}_{a , i - 1} - {φ}_{a , i}}{{k}_{B} T} ) ] {a}_{i - 1}^{j} = \frac{{a}_{i}^{j - 1}}{Δ t} ; \qquad ( 14 )$$
wherein the equation (14) is a discrete form of a combination of the equation (8) and the equation (9), Δt is the unit time step, Dₐ_{_{i+1/2}} is a mean value of an anion diffusion coefficient at the spatial coordinate i and an anion diffusion coefficient at the spatial coordinate i+1,
$$B ( \frac{{φ}_{a , i} - {φ}_{a , i + 1}}{{k}_{B} T} )$$
is a Bernoulli's equation with a variable
$$\frac{{φ}_{a , i} - {φ}_{a , i + 1}}{{k}_{B} T} ,$$
φ_{a,i} is an anion electrostatic potential at the spatial coordinate i, φ_{a,i+1} is an anion electrostatic potential at the spatial coordinate i+1, Dₐ_{_{i−1/2}} is a mean value of an anion diffusion coefficient at the spatial coordinate i−1 and the anion diffusion coefficient at the spatial coordinate i,
$$B ( \frac{{φ}_{a , i} - {φ}_{a , i - 1}}{{k}_{B} T} )$$
is a Bernoulli's equation with a variable
$$\frac{{φ}_{a , i} - {φ}_{a , i - 1}}{{k}_{B} T} ,$$
φ_{a,i-1} is an anion electrostatic potential at the spatial coordinate i−1, aᵢ^{j} is an anion concentration at the spatial coordinate i and the time coordinate j,
$$B ( \frac{{φ}_{a , i + 1} - {φ}_{a , i}}{{k}_{B} T} )$$
is a Bernoulli's equation with a variable
$$\frac{{φ}_{a , i + 1} - {φ}_{a , i}}{{k}_{B} T} ,$$
aᵢ₊₁^{j} is an anion concentration at the spatial coordinate i+1 and the time coordinate j,
$$B ( \frac{{φ}_{a , i - 1} - {φ}_{a , i}}{{k}_{B} T} )$$
is a Bernoulli's equation with a variable
$$\frac{{φ}_{a , i - 1} - {φ}_{a , i}}{{k}_{B} T} ,$$
aᵢ₋₁^{j} is an anion concentration at the spatial coordinate i−1 and the time coordinate j, and aᵢ^{j-1} is an anion concentration at the spatial coordinate i and the time coordinate j−1.

3. The method of claim 1, wherein in the step (S2), if the JV curve type of the solar cell is the type B, the internal loss mechanism is determined as the surface defect of the active layer;
if the JV curve type of the solar cell is the type A, the internal loss mechanism is determined as the bulk defect of the active layer or a combination of the bulk defect and the surface defect of the active layer; and in this case, the voltage scan rate is increased, and the step (S2) is repeated until the JV curve type of the solar cell is the type C or the type D;
if the JV curve type of the solar cell is the type C, the internal loss mechanism is determined as the bulk defect of the active layer; and
if the JV curve type of the solar cell is the type D, the internal loss mechanism is determined as the combination of the bulk defect and the surface defect of the active layer.
